(19) United States
(12) Patent Application Publication
(10) Pub. No.: US 2012/0305035 A1
(43) Pub. Date: Dec. 6, 2012

(54) WATER SCALE REMOVAL OR PREVENTION DEVICES, AND RELATED SIGNAL MODULATORS

(75) Inventors: Kui Yuen Mak, Hong Kong (CN); Juen Gar Newton Wong, Hong Kong (CN)

(73) Assignee: Fukada(Asia) Limited

(21) Appl. No.: 13/578,583

(22) PCT Filed: Jan. 27, 2011
(86) PCT No.: PCT/CN2011/070709

§ 371 Date: Aug. 10, 2012

(30) Foreign Application Priority Data
Feb. 12, 2010 (HK) 1010680.1

(51) Int. Cl. B08B 7/00; B08B 13/00; F15C 1/00; B08B 17/00

(52) U.S. Cl. 134/113; 422/119; 137/803

(57) ABSTRACT

A scale removing or preventing device can send a signal to a hollow body containing a fluid through a wire wound around the hollow body. The device includes a signal generator for generating a signal and a signal modulator for modulating the signal. The signal has a continuous sinusoidal wave form having a parametric representation and a frequency cycle, and a plurality of parametric pieces joined together at respective switching points in the frequency cycle, wherein the first derivatives of the parametric representation of the wave form at the respective switching points are continuous or discontinuous. The provision of a plurality of switching points with continuous or discontinuous first derivations and/or zigzag patterns over the entire signal increases the sudden momentum to the deposition molecules of the scale in each frequency cycle, and thereby increases the mobility of the water scale and removes the scale more effectively.

### FIELD OF THE INVENTION

This invention relates to water scale removal or prevention devices, particularly those using electrical signals to remove or prevent water scale in conduits or other hollow bodies, more particularly in evaporative cooling systems.

### BACKGROUND OF THE INVENTION

Water scale is precipitation of calcium and/or magnesium carbonates in various forms including solid and crystalline forms, which usually affects the surfaces of equipments and facilities. The formation of scale imposes adverse effect on the efficiency of the heat transfer. Such effect increases the consumption of energy of the Heat, Ventilating and Air Conditioning (HVAC) systems where evaporative cooling devices are installed. Water scale builds up on the condenser as a result of continuous evaporation of water over the surface of the heat exchanger. The efficiency of the condenser subsequently decreases because layers of solid insulator on the surface block the heat transfer. The formation of water scale also decreases the flow rate of water throughout HVAC systems.

WO 2006/072125 ('125) describes method and apparatus for water scale removal and prevention using electrical signal without the use of flow rate monitor, which could be used to remove or prevent scales in various liquids including water, beer, juices, and so on by controlling the number of turns per coil of a signal wire around a pipe. The apparatus of '125 uses a non-continuous signal of 750 Hz to 12.5 KHz and a signal amplitude of about 4V, which has a DC offset such that the signal never equals zero. The purpose of the non-continuous signal format is to introduce a dead zone for the provision of a rapid momentum change to the deposited molecules of the scale. However, this relatively short period of momentum change would not be able to induces sufficient shock to the scale. Further, it has been found that the signal of '125 has a relatively high absorption by metal piping.

### OBJECTS OF THE INVENTION

Therefore, it is an object of this invention to resolve at least one or more of the problems as set forth in the prior art. Particularly, it is an object of the current invention to provide scale removing or prevention apparatus that would provide shock to deposited molecules in water scale more effectively. As a minimum, it is an object of this invention to provide the public with a useful choice.

### SUMMARY OF THE INVENTION

Accordingly, this invention provides a scale removing or preventing device for sending a signal to a hollow body containing a fluid through a wire wound around the hollow body. The device includes a signal generator for generating a signal, and a signal modulator for modulating the signal. The signal is modulated to have a continuous sinusoidal wave form having a parametric representation and a frequency cycle, and a plurality of parametric pieces joined together at respective switching points in the frequency cycle, wherein the first derivatives of the parametric representation of said wave form at said respective switching points are continuous or discontinuous.

It is another aspect of this invention to provide a signal modulator for modulating a signal to remove or prevent scale, such that the signal has:
a continuous sinusoidal wave form having a parametric representation; and
a plurality of parametric pieces joined together at respective switching points, wherein the first derivatives of the parametric representation of said wave form at said respective switching points are continuous or discontinuous.

It is yet another aspect of this invention to provide a scale removing or preventing device for sending a signal to a hollow body containing a fluid through a wire wound around the hollow body, said device including:
a signal generator for generating a signal;
a signal modulator for modulating the signal, such that the signal has:
   a) a continuous sinusoidal wave form; and
   b) a continuous zigzag pattern over the entire signal.

It is a further aspect of this invention to provide a signal modulator for modulating a signal to remove or prevent scale, such that the signal has:
a continuous sinusoidal wave form; and
a continuous zigzag pattern over the entire signal.

Preferably, the first derivatives of the parametric representation of said wave form at at least two, more preferably eight, of said respective switching points are discontinuous in the frequency cycle.

Preferably, at least two, more preferably six, of said respective switching points are in the form of a peak in the frequency cycle.

Advantageously, the signal has a continuous zigzag pattern over the entire signal.

Optionally, the wave form has a frequency of from 8 kHz to 21 kHz.

Preferably, the wave form has peak to peak voltage of 10V.

### BRIEF DESCRIPTION OF THE DRAWINGS

Preferred embodiments of the present invention will now be explained by way of example and with reference to the accompanying drawings in which:

FIG. 1 shows an exemplary de-scaling device of this invention installed to a pipe;

FIG. 2 shows an exemplary waveform of the signal in one frequency cycle used in the current invention;

FIG. 3 shows an exemplary circuit diagram of the signal generator;

FIG. 4 shows an exemplary circuit diagram of the signal modulator;

FIG. 5 shows the perspective view of an evaporative cooling condenser installed with the device of the current invention;

FIG. 6 shows the perspective view of another evaporative cooling condenser in installed with the device of the current invention;

FIG. 7 shows wave forms having discontinuing (C(0)) and continuing (C(1)) first derivatives at switching points wherein two parametric pieces join.

### DETAILED DESCRIPTION OF THE PREFERRED EMBODIMENTS

This invention is now described by way of example with reference to the figures in the following paragraphs. List 1 below is a part list so that the reference numerals in the figures may be easily referred to.

List 1

| Reference | |
|---|---|
| Numerals | Description |
| 10 | De-scaling device |
| 20 | Signal generator |
| 30 | Terminal |
| 40 | Signal cable |
| 50 | Pipe |
| 60 | Coil |
| 70 | Fluid |
| 310 | Signal |
| 330 | Non smooth sinusoidal wave |
| 510 | Incoming water pipe |
| 520 | Water spray |
| 530 | Water nozzles |
| 570 | Filter |
| 580 | Heat exchange |
| 611 | Evaporative cooling condenser |
| 620 | Exhaustion fan |
| 640 | Air flow into condenser |
| 650 | Air flow out of condenser |

Objects, features, and aspects of the present invention are disclosed in or are apparent from the following description. It is to be understood by one of ordinary skilled in the art that the present discussion is a description of exemplary embodiments only, and is not intended as limiting the broader aspects of the present invention, which broader aspects are embodied in the exemplary constructions.

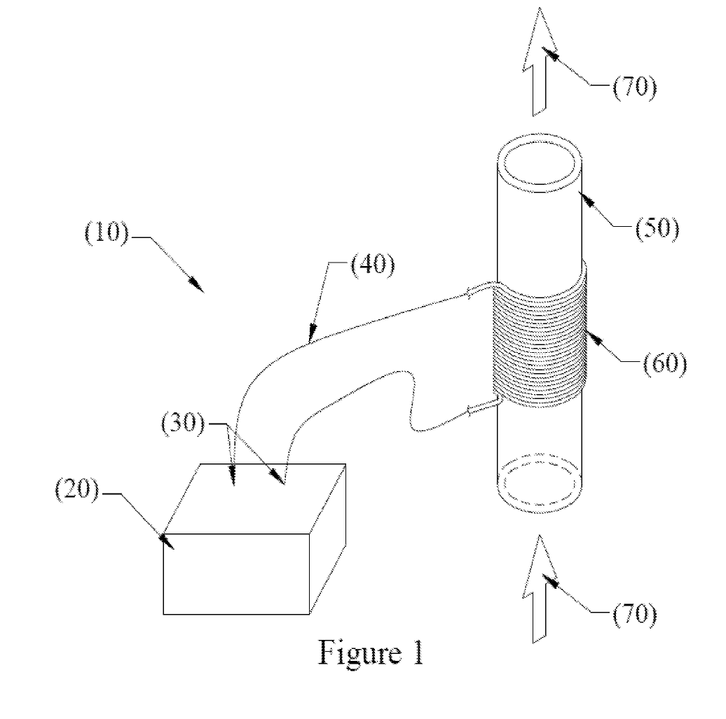

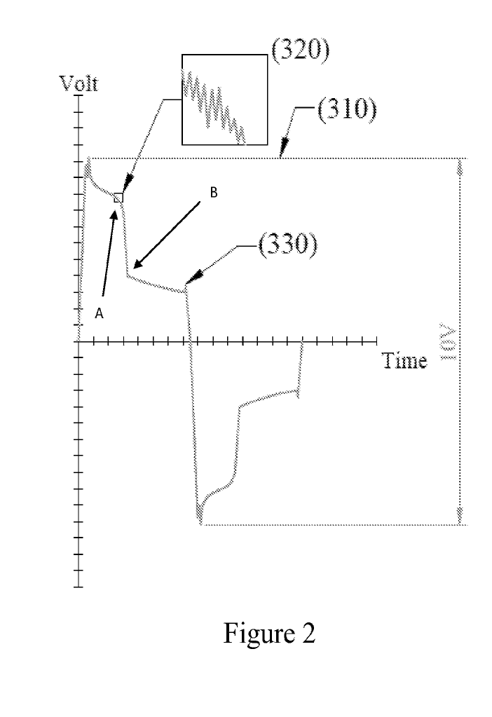

Referring to FIG. 1, a de-scaling device 10 of this invention includes a signal generator 20 and a signal modulator. In use, the de-scaling device 10 is connected to two terminals 30, which is then connected to a signal cable 40. The signal cable 40 is wound around the pipe 50 to form one or more coil 60 into the fluid 70, which could be chilling water or other types of water containing liquid, passing through the pipe 50. Energy in the form of waves (not shown) is induced into the fluid 70 once it pass through the coil 60, which is connected to a signal generator with a pulsing signal 310 (shown in FIG. 2).

An exemplary wave form generated by the signal generator 20 and the signal modulator of the current invention is shown in FIG. 2. The signal 310 is frequency regulated with a combination of a continuous sinusoidal wave form with various other wave forms, including square wave, triangle wave, and stepped saw tooth wave. The purpose of the signal 310 is to provide mobilization to deposition molecules in the water 70 usually found in the HVAC system. The signal 310 is basically a non smooth sinusoidal wave 330 to produce sudden momentum to the deposition molecules of the scale in each frequency cycle. Non smooth sinusoidal wave 330 is also helpful to prevent a permanent polarization effect, which occurs when a continuous magnetic field is applied which will reduce the effectiveness of the de-scaling effect.

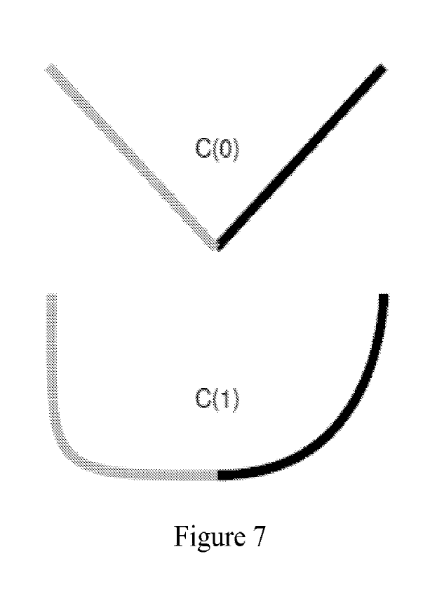

The signal 310 has a continuous sinusoidal wave form having a parametric representation and a frequency cycle, and a plurality of parametric pieces joined together at respective switching points, wherein the first derivatives of the parametric representation of said wave form at said respective switching points are continuous or discontinuous. FIG. 7 shows different forms of parametric pieces joined together at switching points, in which a discontinuity in the first derivative (the curve is C(0) but not C(1)) is usually noticeable because it leads to a sharp corner. Returning to FIG. 2, the switching point A of the non smooth sinusoidal wave 330 has a discontinuous first derivative, while the first derivative of the switching point B is continuous. The number of switching points in the non smooth sinusoidal wave 330, and the combination of switching points with discontinuous and continuous first derivatives in one frequency cycle can vary as desired. It is preferred to have as many switching points with discontinuous first derivatives as practicably possible, although as few as two could work. For example, the non smooth sinusoidal wave 330 may have 2 to 20, preferably 4 to 10, switching points with discontinuous and continuous first derivatives in one frequency cycle, and 3 to 17, preferably 4 to 10, of these may have discontinuous and continuous first derivatives. The non smooth sinusoidal wave 330 in FIG. 2 has eight switching points with discontinuous first derivatives in one frequency cycle. To further enhance the sudden momentum to the deposition molecules of the scale, the switching points could be in the form of a peak, and the non smooth sinusoidal wave 330 in FIG. 2 has six peaks in one frequency cycle.

Additionally, non smooth zigzag patterns 320 are found all over the signal 310 to provide continuous momentum charge to the deposition molecules in the fluid 70 and to prevent a permanent polarization effect, which occurs when a continuous magnetic field is applied which will reduce the effectiveness of the de-scaling effect.

The provision of a plurality of switching points with continuous or discontinuous first derivatives and/or zigzag patterns over the entire signal 310 increases the sudden momentum to the deposition molecules of the scale in each frequency cycle, and thereby increases the mobility of the water scale formed and thereby removing the scale more effectively.

Further, the signal 310 has a relatively high frequency of about 8 kHz to 21 kHz to compensate the loss of wave energy due to the high frequency wave absorption nature of metallic material, which is commonly used to manufacture the pipes 50 and fitting in HVAC system. For ferrous piping, 20% to 25% extra provision to the high frequency zone should be provided for exceptional high absorption nature of iron pipe 50.

For the same reason, i.e. compensation for the loss due to absorption behaviour of metal pipe 50, a relative high voltage output, i.e. 10V peak to peak amplitude, of signal 310 should be provided.

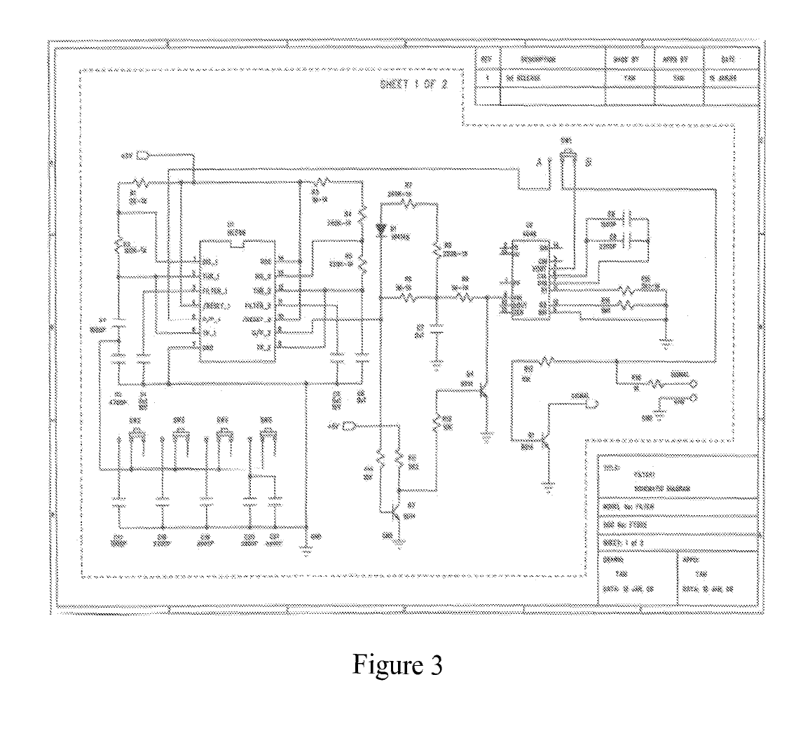

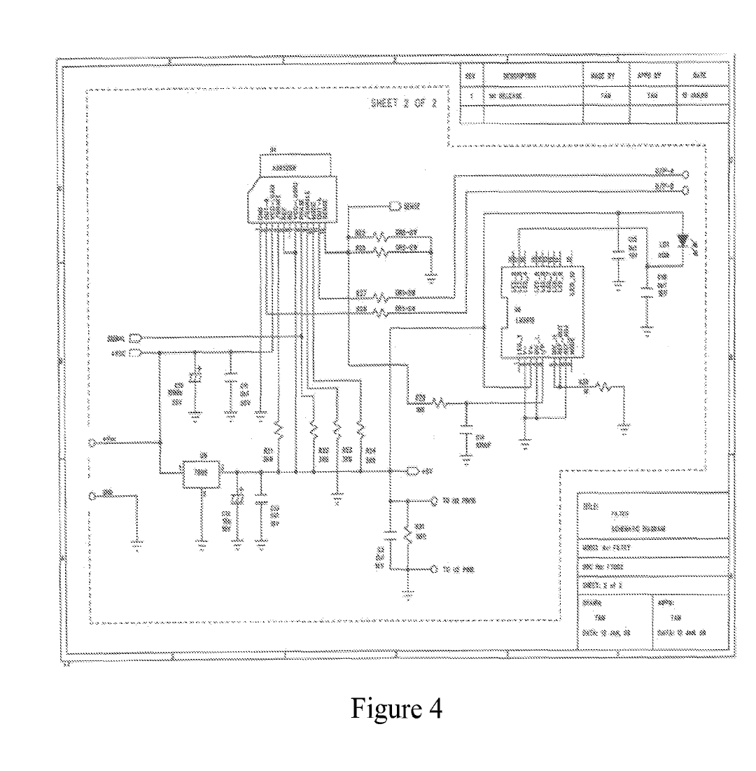

FIG. 3 shows an exemplary circuit diagram of the signal generator, and FIG. 4 shows an exemplary circuit diagram of the signal modulator. Once the form of the non smooth sinusoidal wave 330 of the signal 310 is determined, the circuits of the signal generator and the signal modulator could be devised in a relatively straight forward manner by an electronic engineer.

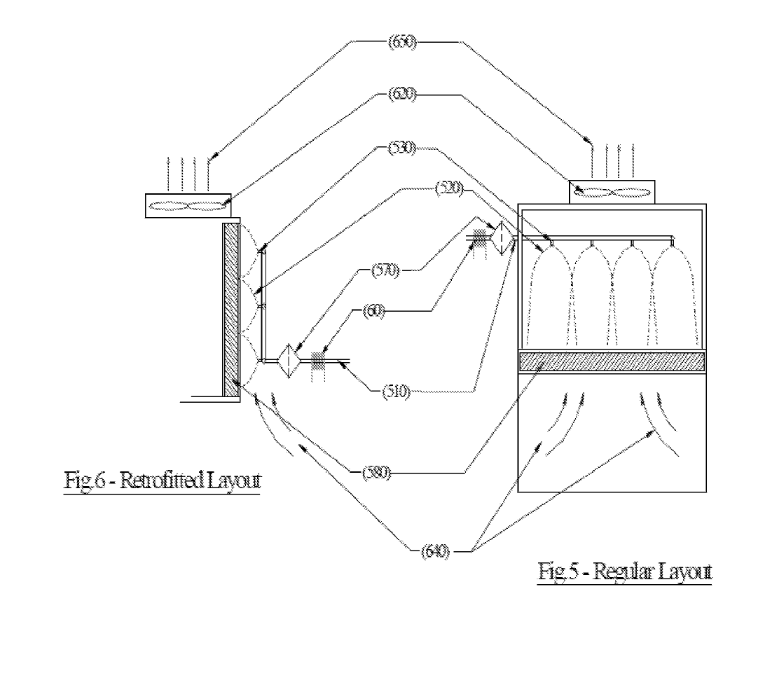

FIGS. 5 and 6 show how the de-scaling device 10 of this invention could be applied in evaporative cooling systems. The coil 60, which is connected to pulsing current generator 20 via the signal cable 40 (not shown in FIGS. 5 and 6 but shown in FIG. 1) is installed on the incoming water pipe 510. In the operation of evaporative cooling systems where water is pumped via the incoming water piping 510 and turning into water spray 520 after passing through the water nozzles 530 pressurized by a pump (not shown) installed in the evaporative cooling condenser 611. The water spray 520 deposits evenly on the surface of heat exchange 580. The water evaporates quickly on the surface condenser coil due to a fast evaporation process taken place inside the evaporative cooling condenser 611, where there is an airflow into the condenser 640 and airflow out of the condenser 650 created by exhaustion fan 620 that creates a negative pressure inside the cavity of the evaporative cooling condenser 611. While most of the water molecules leave the evaporative cooling condenser through the air flow out of the condenser 650, water scale is left behind and formed a layer of residuals (not shown) on the surfaced of heat exchanger 580. Since water scale is a good heat insulator, the heat exchange efficiency of the evaporative cooling condenser 611 decreases as the thickness of the water scale increases over time. In order to restore the efficiency of the evaporative cooling condenser 611, the coil 60 connected with signal generator 20 and filter 570 automatically remove the water scale from the heat exchanger 580 and reduce the likeness of the formation of water scale over the surface of condenser 580 without application of chemical dosage and huge effort of regular maintenance.

The coil 60, which is connected to pulsing current generator 20, delivers the signal 310 over the water in evaporative cooling system. The scale forming materials gradually break down and turn into aragonite, which is a stable crystallized particle that can be carried away in suspension with water. Water containing the aragonite goes through the filter 570 installed along the incoming water piping 510. The screen of filter 570, preferably made of non corrosive-resistant material, collects the suspended aragonite in the water.

While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

1. A scale removing or preventing device for sending a signal to a hollow body containing a fluid through a wire wound around the hollow body, said device including:
a signal generator for generating a signal;
a signal modulator for modulating the signal, such that the signal has:
a) a continuous sinusoidal wave form having a parametric representation and a frequency cycle; and
b) a plurality of parametric pieces joined together at respective switching points in the frequency cycle, wherein the first derivatives of the parametric representation of said wave form at said respective switching points are continuous or discontinuous.

2. The scale removing or preventing device of claim 1, wherein the first derivatives of the parametric representation of said wave form at at least two of said respective switching points are discontinuous in the frequency cycle.

3. The scale removing or preventing device of claim 2, wherein the first derivatives of the parametric representation of said wave form at least eight of said respective switching points are discontinuous in the frequency cycle.

4. The scale removing or preventing device of claim 1, wherein at least two of said respective switching points are in the form of a peak in the frequency cycle.

5. The scale removing or preventing device of claim 4, wherein at least six of said respective switching points are in the form of a peak in the frequency cycle.

6. The scale removing or preventing device of claim 1, wherein the signal has a continuous zigzag pattern over the entire signal.

7. The scale removing or preventing device of claim 1, wherein the wave form has a frequency of from 8 kHz to 21 kHz.

8. The scale removing or preventing device of 7 claim 1, wherein the wave form has peak to peak voltage of 10V.

9. A signal modulator for modulating a signal to remove or prevent scale, such that the signal has:
a continuous sinusoidal wave form having a parametric representation; and
a plurality of parametric pieces joined together at respective switching points, wherein the first derivatives of the parametric representation of said wave form at said respective switching points are continuous or discontinuous.

10. A scale removing or preventing device for sending a signal to a hollow body containing a fluid through a wire wound around the hollow body, said device including:
a signal generator for generating a signal;
a signal modulator for modulating the signal, such that the signal has:
c) a continuous sinusoidal wave form; and
d) a continuous zigzag pattern over the entire signal.

11. The scale removing or preventing device of claim 10, wherein the wave form has a parametric representation, and the signal has a plurality of parametric pieces joined together at respective switching points, wherein the first derivatives of the parametric representation of said wave form at said respective switching points are continuous or discontinuous.

12. A signal modulator for modulating a signal to remove or prevent scale, such that the signal has:
a continuous sinusoidal wave form; and
a continuous zigzag pattern over the entire signal.
